(19) United States
(12) Patent Application Publication
(10) Pub. No.: US 2007/0240798 A1
(43) Pub. Date: Oct. 18, 2007

(54) Theft Resistant Personal Property Carrying Devices

(76) Inventor: Daniel Gary Bihler, Chicago, IL (US)

Correspondence Address: CARDINAL LAW GROUP, Suite 2000, 1603 Orrington Avenue, Evanston, IL, 60201, US

(21) Appl. No.: 11/737,022

(22) Filed: Apr. 18, 2007

Related U.S. Application Data
(60) Provisional application No. 60/792,702, filed on Apr. 18, 2006.

(51) Int. Cl. E05B 67/38; A45C 13/18

(52) U.S. Cl. 150/102; 70/68

(57) ABSTRACT

A personal property carrying device, such as a handbag, or a suitcase including a body and a strap. The strap being lockable to the body by use of a locking device to prevent theft of the personal property carrying device. A zipper on the top of the bag is also lockable to the locking device.

### RELATED APPLICATIONS

This application claims the benefit of United States Provisional Patent Application 60/792,702 filed Apr. 18, 2006, the entirety of which is incorporated herein by reference.

### FIELD OF THE INVENTION

This invention relates generally to personal property carrying devices.

### BACKGROUND OF THE INVENTION

Personal property carrying devices, such as purses, handbags, briefcases, backpacks are subject to theft. The theft of such personal property carrying devices, or bags, is troubling, not only due to the loss of the bag, but also to money, identification, credit cards, etc. that are often located within the bag. The bag can be taken from its resting place or from other locations. Often, the owner of the bag can attempt to dissuade potential thieves by hooking a bag strap to a more secure object, such as a larger object or a relatively immovable object. For example, a bag strap can be looped to a chair, bar stool, or the like. However, a motivated thief can simply cut the strap to take the bag.

Due to the theft potential of the bag, it would be desirable to utilize a bag that is secure, theft resistant and easily secured to a stationary object.

### SUMMARY OF THE INVENTION

A first aspect of the invention includes a personal property carrying device that includes a body and a strap. The body includes a locking side and the strap includes a first end and a second end. The device further includes a locking device attached to the locking side of the body. The locking device has a hinged arm and a combination lock to secure the hinged arm in a locked position, wherein the locking device defines a substantially continuous loop in a locked configuration, and wherein the locking device defines a non-continuous loop in an open configuration.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 is a front view of an embodiment of a personal property carrying device, illustrated as a bag, in accordance with one aspect of the invention;

FIGS. 2 and 3 are side views of the bag of FIG. 1 in accordance with one aspect of the invention;

FIGS. 4 and 5 are detail views of the locking device of FIG. 1 showing how the strap is secured to the bag, in accordance with one aspect of the invention;

FIGS. 6 and 7 are detail views of the locking device of FIG. 1 showing how the strap is secured to the bag, in accordance with another aspect of the invention;

FIGS. 8-10 are detail views of the locking device of FIG. 1 showing how the strap is secured to the bag, in accordance with a further aspect of the invention;

FIG. 11 is a front view of an alternate embodiment of the bag, in accordance with another aspect of the invention;

FIG. 12 is a side view of the alternate embodiment of the bag of FIG. 11, in accordance with another aspect of the invention;

FIG. 13 is a front view of another alternate embodiment of the bag, in accordance with another aspect of the invention;

FIG. 14 is a side view of the alternate embodiment of the bag of FIG. 13, in accordance with another aspect of the invention;

FIG. 15 is a front view of further alternate embodiment of the bag, in accordance with another aspect of the invention;

FIG. 16 is a top view of alternate embodiment of the bag of FIG. 15, in accordance with another aspect of the invention; and

FIG. 17 is a bottom view of the alternate embodiment of the bag of FIG. 15, in accordance with another aspect of the invention.

FIG. 18 illustrates a method for securing the bag in accordance with another aspect of the invention.

### DETAILED DESCRIPTION OF THE DRAWINGS

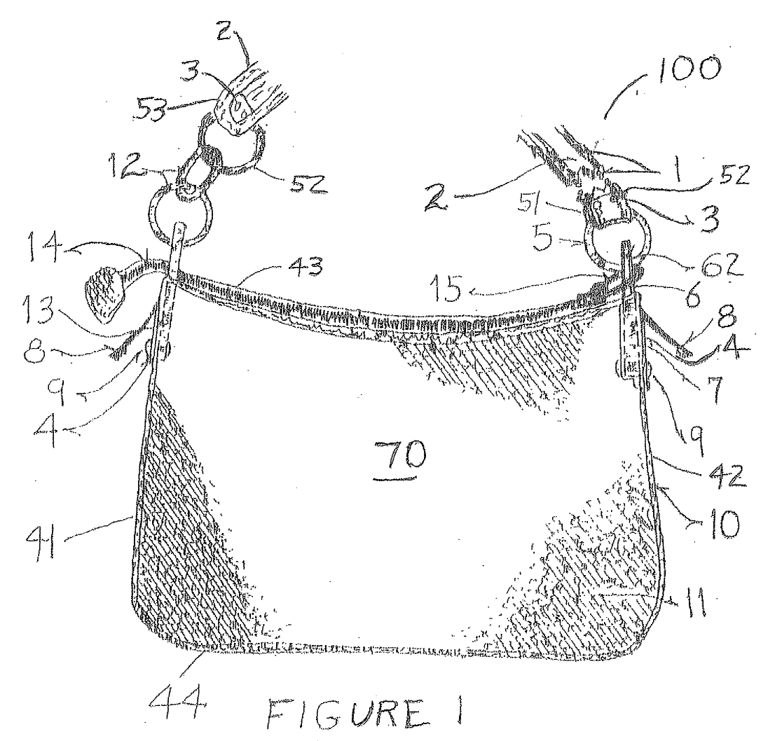

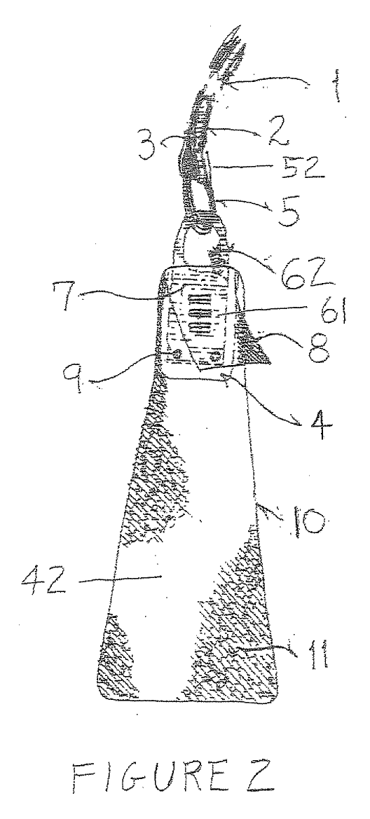

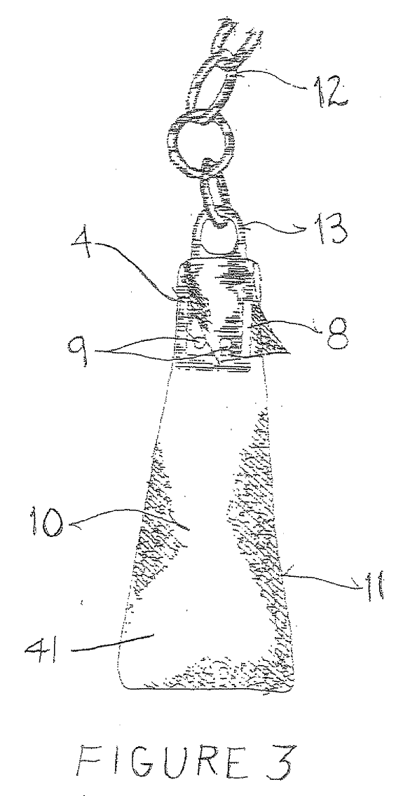

FIG. 1 illustrates a front view of a personal property carrying device 100 in accordance with one aspect of the invention. In one embodiment, the personal property carrying device 100 is a bag. In other embodiments, the personal property carrying device 100 is a briefcase, suitcase, purse, handbag, backpack, beach bag, or carry-all. FIGS. 2 and 3 are side views of FIG. 1. The bag 100 includes a body 10 including a front 11, a first side 41, a second side 42, a top 43 and a bottom 44. The bag 100 includes a strap 2 to facilitate carrying by a person. In one embodiment, the strap includes metal cables 1, a strap first end 51 and a strap second end 53. In one embodiment, each end includes a strap loop 52 and in certain embodiments a fastener 3, such as a rivet securing the strap loop 52 in position. In one embodiment, a locking ring 5 is positioned within each strap loop 52.

In one embodiment, a locking device 6 is attached to the body 10 by a fastener 9, such as a rivet. A backing plate 4, in one embodiment, is used to provide additional support for the locking device. The locking device 6 includes a locking device body 7. A cover 8 is attached to the locking device body 7 to conceal the locking device in one embodiment. In one embodiment, a hinged arm 62 on the locking device 6 allows the locking device to be attached to the locking ring 5. In one embodiment, a combination lock 61 (FIG. 2) on the locking device body allows the hinged arm to be releasably attached to the locking device body 7.

In one embodiment, the strap second end 53 is attached to a chain 12. In one embodiment, the body 10 of the bag 100 includes a metal bracket 13 attached to an upper portion of the first side 41 of the body 10 by a fastener 9, such as a rivet. In one embodiment, the chain 12 is attached through an aperture 63 to the metal bracket 13 and through the strap loop 52, so that the strap 2 is attached to the body 10. In one embodiment, the cover 8 also conceals the fastener 9, attaching the metal bracket to the body 10 from view.

In one embodiment, a zipper 14 on the top 43 of the bag 100 allows access to the interior 70 of the bag 100. In one embodiment, a locking ring 15 secures the zipper 14 to the hinged arm 62 of the locking device 6 in order to discourage unauthorized access to the bag.

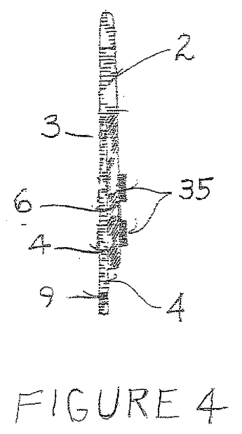

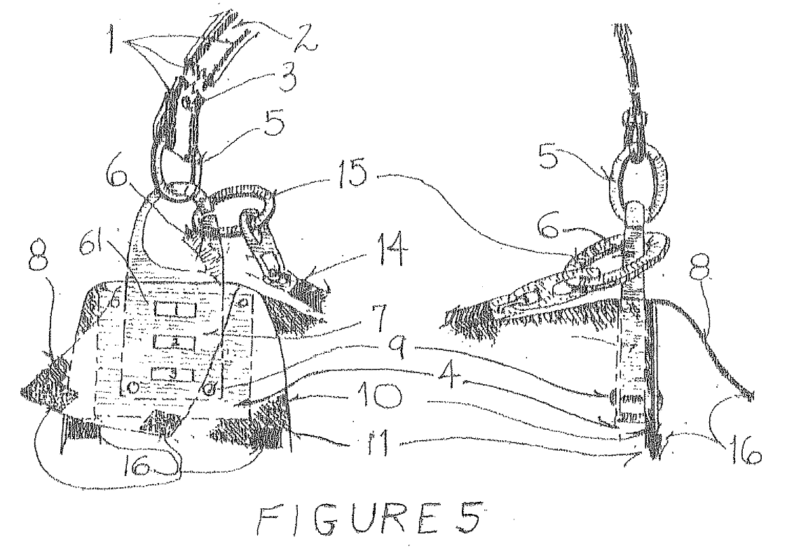

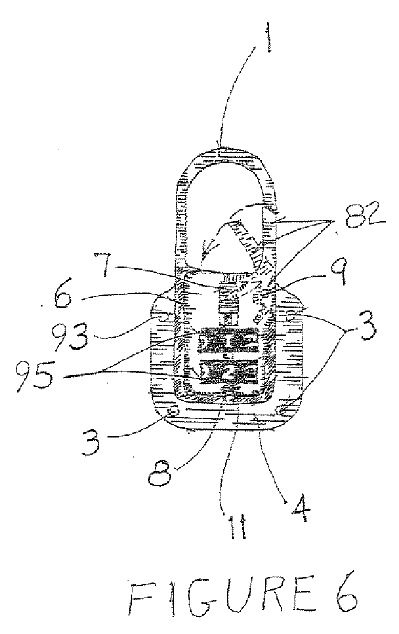

FIGS. 4-6 are detail views of the locking device 6 of FIG. 1. FIGS. 4-6 also illustrate the attachment of the locking device 6 to the strap 2. For brevity, reference numbers illustrated on FIGS. 4-6, which have already been identified, are not repeated, except when pertinent. In one embodiment, two tumblers 95 allow a hinged arm 82 to be unlocked from the locking device body 7.

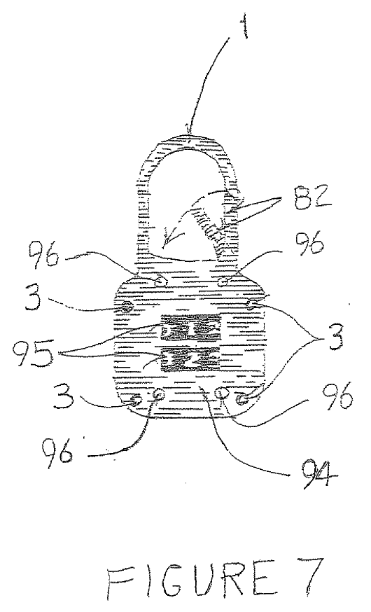

FIG. 7 is an alternative embodiment of a detail view of the locking device of 6 of FIG. 1. For brevity, reference numbers illustrated on FIGS. 4-7, which have already been identified, are not repeated, except when pertinent. In the embodiment of FIG. 7, the locking device body 6 and backing plate 7 are integrally formed as integral locking body 94. In the embodiment of FIG. 7, fasteners 96 are used to fasten the integral locking body to the body 10 first side 41, in addition to the fasteners 3.

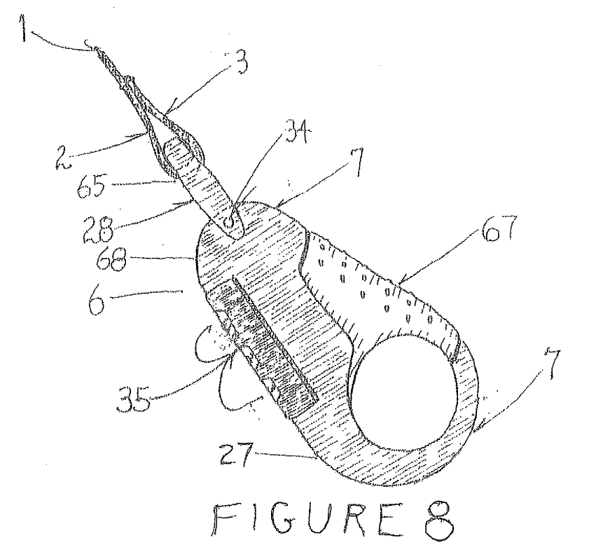

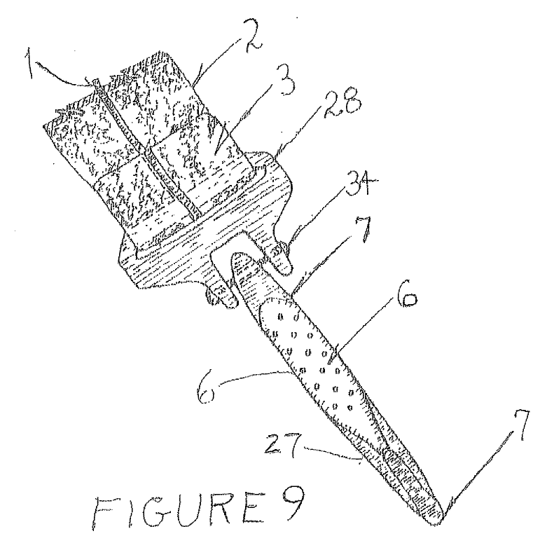

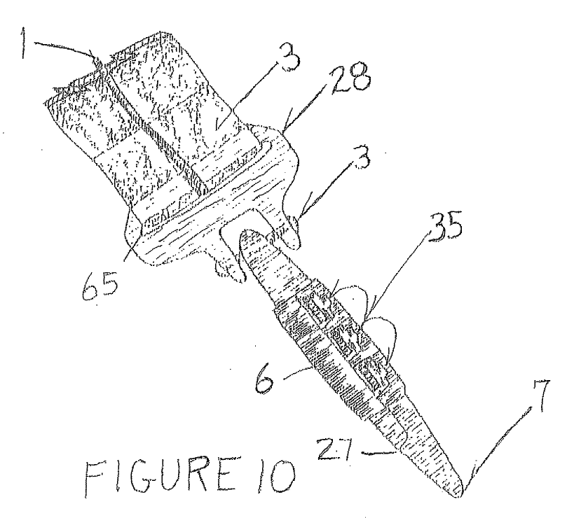

FIGS. 8-10 are detail views of the locking device 6 according to a further embodiment of the invention. In the embodiment of FIGS. 8-10, the strap 2 is connected to the locking device 6 by the use of a swivel bracket 28. In FIGS. 8-10, the locking device is configured as a D-ring 27. The D-ring 27 includes a D-ring body 68. In one embodiment, the loop 52 on the strap 2 passes through an aperture 65 in the swivel bracket 28 to secure the strap 2 to the swivel bracket 28. In one embodiment, the swivel bracket 28 is attached to the locking device 7 by a pivot pin 34. In the embodiment of FIGS. 8-10, three tumblers 35 allow a locking device pivoting arm 67 to be unlocked from the locking device body 7. Cable 1 is made of a metal, in on embodiment, and provides support reinforcement to the strap. In one embodiment, D-ring 27 is a carabiner. In one embodiment, d-ring 27 includes a hinged arm operable to assume a locked configuration and an open configuration, a combination lock on a side of the d-ring opposing the hinged arm, and a wall defining a lumen such that when the hinged arm is in the locked configuration, the lumen is defined by a substantially continuous surface, and when the hinged arm is in an open configuration, the substantially continuous surface includes a substantial discontinuity defined by the range of motion of the hinged arm. In one embodiment, the hinged arm is configured to rotate only along a predetermined range of rotation. In other embodiments, the locking device is configured as an o-ring (not pictured).

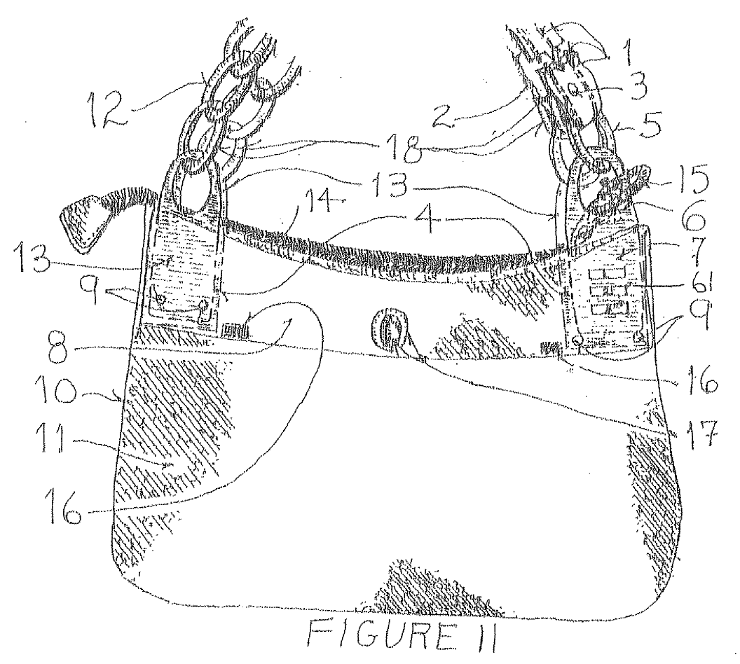

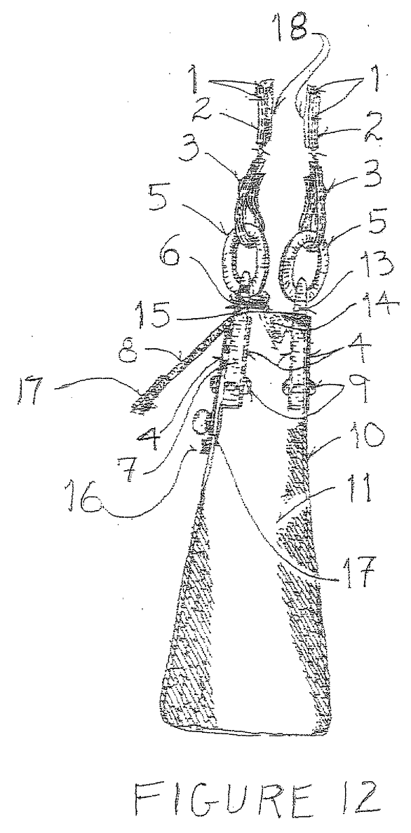

FIG. 11 illustrates a front view of a personal property carrying device, or bag 100 in accordance with another aspect of the invention. FIG. 12 is a side view of the device illustrates in FIG. 11. For brevity, reference numbers illustrated on FIGS. 11 and 12, which have already been identified, are not repeated, except when pertinent. FIGS. 11 and 12 illustrate a “double strap” embodiment, utilizing two straps 2, instead of one,. FIGS. 11 and 12 also show the use of a hook-and-loop fastener 16 and a snap fastener 17 to secure the cover 8 to the body 10. Although embodiments including one strap and two straps are illustrated, any number of straps can be used in accordance with the disclosures herein.

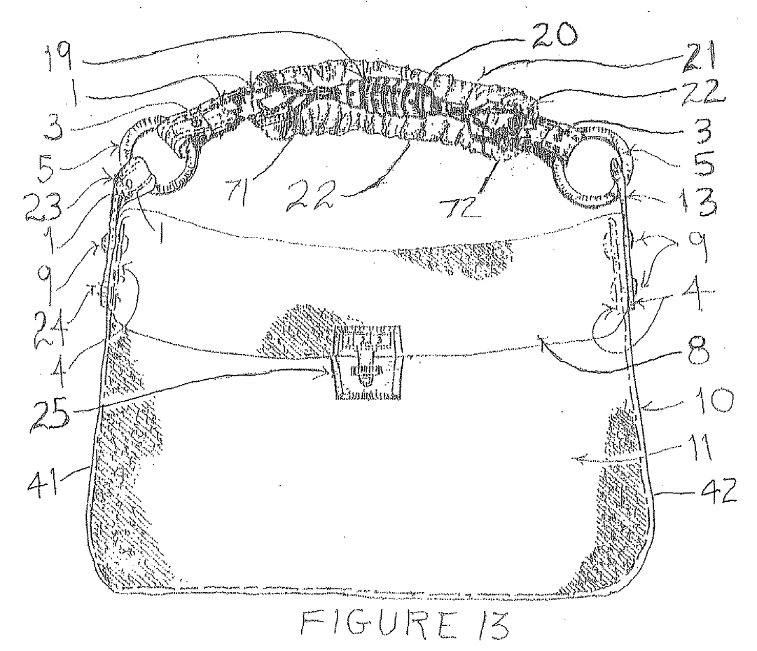

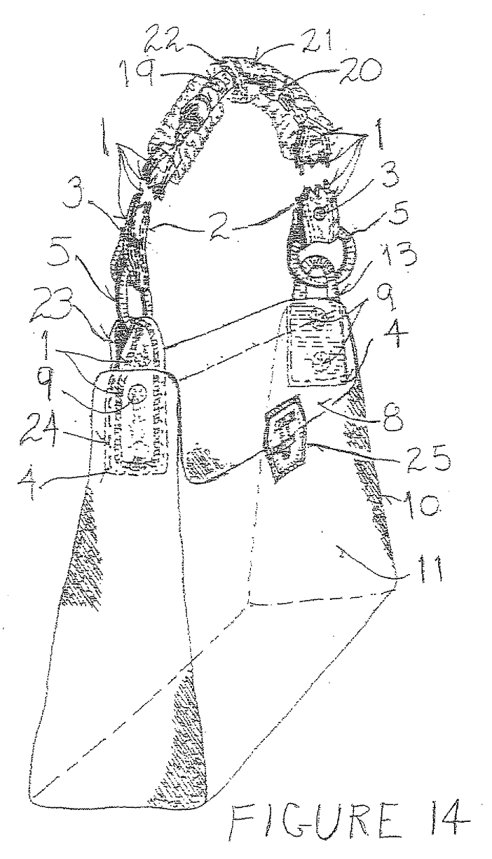

FIG. 13 illustrates a front view of a personal property carrying device, or bag 100 in accordance with another aspect of the invention. FIG. 14 is a side view of the device illustrated in FIG. 13. For brevity, reference numbers illustrated on FIGS. 13 and 14, which have already been identified, are not repeated, except when pertinent. In FIGS. 13 and 14 cable lock 19 connects first strap part 71 and a second strap part 72. Tumblers 20 allow the cable lock 19, when locked, to be disengaged. In one embodiment, a lock cover 21 and padding 22 cover the lock, to conceal the lock from view, and to allow the strap with the cable lock to be placed over one's shoulder, without experiencing discomfort. FIGS. 13 and 14 also illustrate the use of a locking device loop 23 with metal cables 1 to connect the locking ring 5 to the metal bracket 13. FIGS. 13 and 14 additionally illustrate the use of a reinforcement strap 24 to strengthen the attachment area of the metal bracket 13 to an inside surface of the first side 41 of the bag 100. In embodiments with a reinforcement strap, the strap may be attached to the bag 100 by stitching, as well as by fastener 9, or other appropriate fastening techniques. FIGS. 13 and 14 further illustrate the use of a brief case type lock 25 to attach the cover 8 to the front 11 of the bag 100.

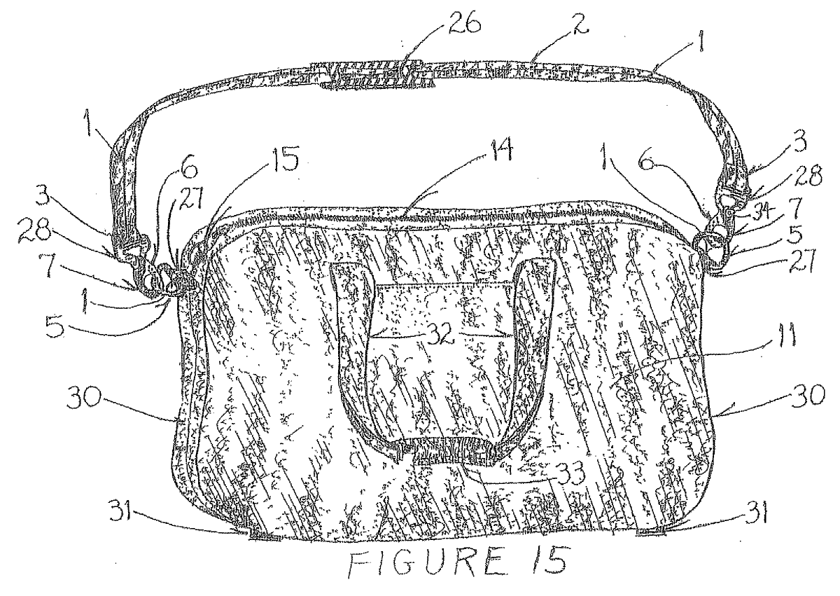

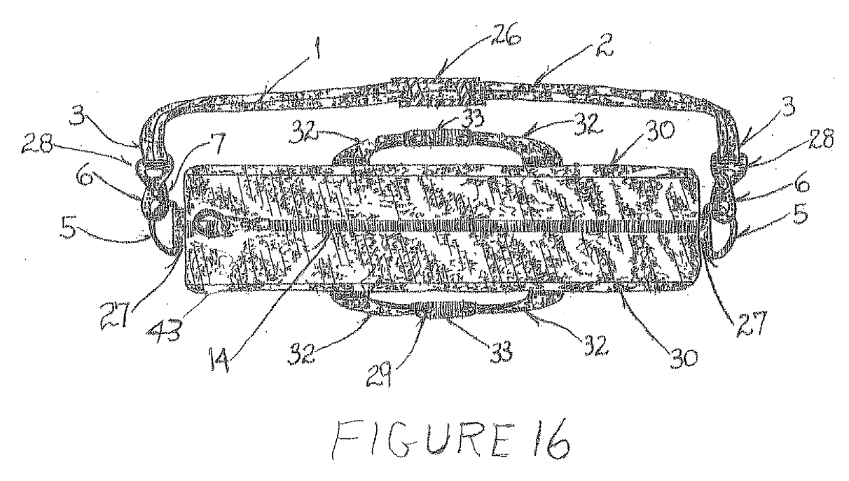

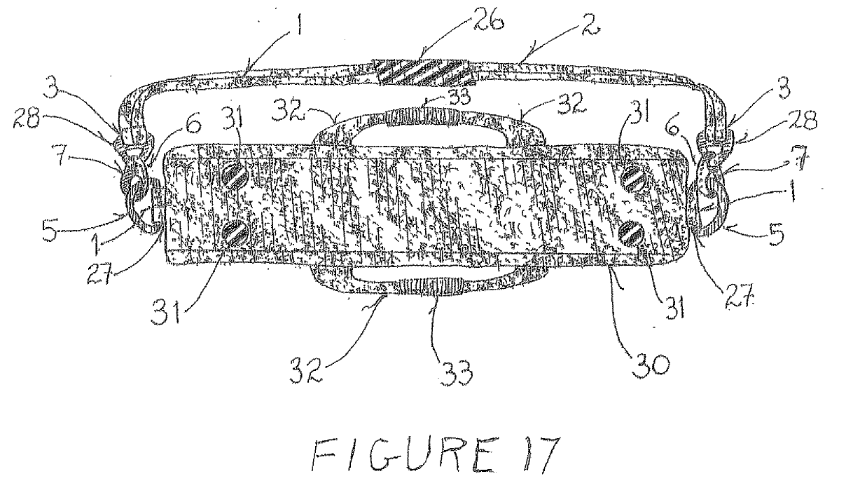

FIG. 15 illustrates a front view of a personal property carrying device, or bag 100 in accordance with another aspect of the invention. FIGS. 16 is a top view of the device illustrates in FIG. 15. FIG. 17 is a bottom view of the device illustrated in FIG. 15. For brevity, reference numbers illustrated on FIGS. 15-17, which have already been identified, are not repeated, except when pertinent. Reference number 30 illustrates an alternate configuration of the bag 100, shown on FIG. 1. The embodiment of FIGS. 15-17 utilizes a single strap 2 with a shoulder strap pad 26. The further embodiment of FIGS. 15-17 also utilizes the locking device 7 configured as a D-ring 27, and utilizing swivel bracket 28, as set forth in FIGS. 8-10. The further embodiment of FIGS. 15-17 also utilizes side straps 32 which are releasably joined to each other by a snap closure 29. A padded handle 33 covers the snap closure 29. The further embodiment of FIGS. 15-17 also utilizes pad, or feet 31 on the bottom 41 of the bag 30.

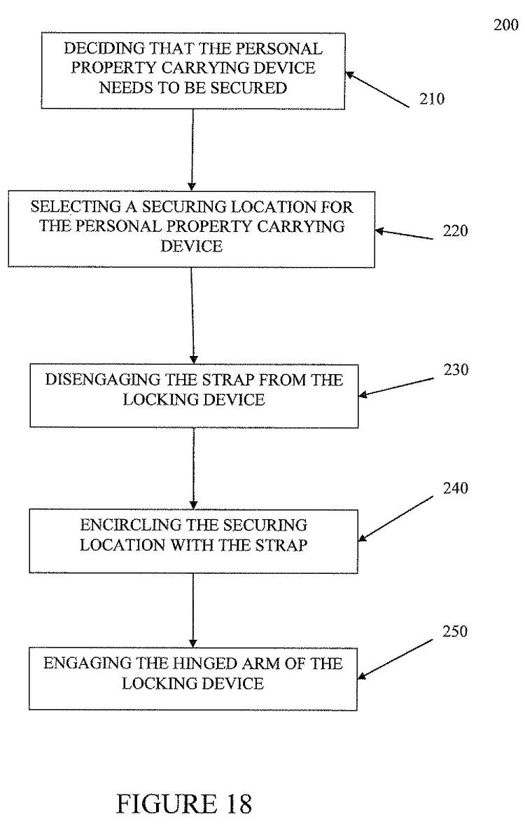

FIG. 18 illustrates a method for securing the bag in accordance with one aspect of the invention. The method 200 of FIG. 18 includes the steps of, deciding that the personal property carrying device needs to be secured 210, selecting a securing location for the personal property device 220, disengaging the strap from the locking device 230, encircling the securing location with the strap 240, engaging the hinged arm of the locking device so that the device is secured 250.

The metallic structures herein can comprise any appropriate material, such as a hardened metal, steel, aluminum alloy, cold rolled steel, brass, copper, silver, gold, or the like. Alternatively, the metallic structures can be implemented as an appropriate ceramic or polymer with the desirable characteristics including resistance to cutting tools. Fasteners can be threaded or unthreaded. The straps can be made of any fabric, leather, or commercial product, such as vinyl or plastics.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced herein.

What is claimed is:

1. A personal property carrying device comprising:
a body including a locking side;
a strap including a first end and a second end;
a locking device attached to the locking side of the body, the locking device having a hinged arm and a combination lock to secure the hinged arm in a locked position, wherein the locking device defines a substantially continuous loop in a locked configuration, and wherein the locking device defines a non-continuous loop in an open configuration.

2. The personal property carrying device according to claim 1, wherein the device is selected from the group consisting of a handbag, a purse, a briefcase, a beach bag, a backpack, and a suitcase.

3. The personal property carrying device according to claim 2, further comprising a closure device, the closure device configured to control access to an interior of the body.

4. The personal property carrying device according to claim 3, wherein the closure device is a zipper.

5. The personal property carrying device according to claim 4, wherein the zipper includes a locking ring that is lockably attachable to the locking device.

6. The personal property carrying device according to claim 1, further comprising a cover covering the locking device.

7. The personal property carrying device according to claim 6, wherein the cover is attachable to the body by at least one of the group consisting of hoop and loop fasteners, zipper, and snap closure.

8. The personal property carrying device according to claim 1, wherein at least one of the first end and second end of the strap is connected to a metal plate, the metal plate connected to an interior side of the body.

9. The personal property carrying device according to claim 1, further comprising a chain connected to the second end of the strap and the second side of the body.

10. The personal property carrying device according to claim 9, wherein the chain is connected to a metal bracket, the metal bracket connected to an interior side of the second side of the body.

11. The personal property carrying device according to claim 1, wherein the strap includes at least one metal cable.

12. The personal property carrying device according to claim 1, wherein the strap includes padding.

13. The personal property carrying device according to claim 1, wherein the strap is formed of a first strap part and a second strap part, the first and second strap parts connected by a cable lock.

14. The personal property carrying device according to claim 1, wherein the locking device includes a D-ring.

15. The personal property carrying device according to claim 14, wherein the D-ring includes a D-ring body, the hinged arm being pivotally attached to the D-ring body to assume an open configuration and a locked configuration.

16. The personal property carrying device according to claim 15, further comprising a swivel bracket connecting the D-ring to the strap.

17. The personal property carrying device according to claim 1, further comprising a side strap connected to the body.

18. The personal property carrying device according to claim 1, further comprising at least one pad.

19. A method of securing a personal property carrying device, the method comprising:
deciding that the personal property carrying device needs to be secured;
selecting a securing location for the personal property carrying device;
disengaging the strap from the locking device;
encircling the securing location with the strap;
engaging the hinged arm of the locking device so that the device is secured.

20. A personal property carrying device comprising:
a body including a top, a bottom, a first side and a second side, wherein the body is selected from the group consisting of a handbag, a purse, a briefcase, a beach bag, a backpack, and a suitcase, wherein at least one of the front and back of the body includes a side strap, wherein the bottom includes at least one pad;
a strap including a first end and a second end, wherein the strap includes at least one metal cable, wherein the strap is formed of a first strap part and a second strap part, the first and second strap parts being lockably connected by a cable lock;
a locking device attached to the locking side of the body, the locking device having a hinged arm and a combination lock, wherein the locking device and the first end define a substantially continuous loop in a locked configuration, and wherein the locking device defines a non-continuous loop in an open configuration, wherein the zipper includes a locking ring that is lockably attachable to the hinged arm, wherein the locking device includes a D-ring, wherein the D-ring includes a D-ring body, the hinged arm being pivotally attached to the D-ring body, the hinged arm being releasably attached to the D-ring body by use of a combination lock, wherein the D-ring body is attached to the strap by a swivel bracket;
the personal property carrying device further comprising a closure device, the closure device configured to control access to an interior of the body, wherein the closure device is a zipper;
the personal property carrying device further comprising a cover, the cover operably disposed to restrict access to the locking device, wherein the cover is attachable to the front of the body by at least one the group consisting of hoop and loop fasteners, zipper, and snap closure;
wherein at least one of the first end and second end of the strap is connected to a metal plate, the metal plate connected to an interior side of the body;
the personal property carrying device further comprising a chain connected to the second end of the strap and the second side of the body, wherein the chain is connected to a metal bracket, the metal bracket connected to an interior side of the second side of the body.
